(19) United States
(12) Patent Application Publication
(10) Pub. No.: US 2009/0063400 A1
(43) Pub. Date: Mar. 5, 2009

(54) APPARATUS, SYSTEM, AND METHOD FOR IMPROVING UPDATE PERFORMANCE FOR INDEXING USING DELTA KEY UPDATES

(75) Inventors: Dipti D. Borkar, San Jose, CA (US); Christina M. Lee, San Jose, CA (US); Robert W. Lyle, Morgan Hill, CA (US)

Correspondence Address: Kunzler & McKenzie, 8 EAST BROADWAY, SUITE 600, SALT LAKE CITY, UT, 84111, US

(73) Assignee: International Business Machines Corporation, Armonk, NY (US)

(21) Appl. No.: 11/850,443

(22) Filed: Sep. 5, 2007

(51) Int. Cl. G06F 17/30

(52) U.S. Cl. 707/2; 707/E17.002

(57) ABSTRACT

An apparatus, system, and method are disclosed for updating database indexes on complex data types. Instead of deleting all the index keys for an old indexable entity, only the old index keys which are not in the set of new index keys associated with a replacement indexable entity will be deleted. In addition, only new index keys which are not in the set of old index keys are inserted into the index. In this manner, performance is greatly improved by elimination unnecessary deletions and insertions to an index.

### BACKGROUND OF THE INVENTION

1. Field of the Invention

This invention relates to indexing in a database and more particularly relates to improving update performance for indexes using delta key updates.

2. Description of the Related Art

In a database, an index can be created on one or more columns in a table. Updates to values in relational table columns can be processed as a deletion of old values and insertion of new values. When an index exists on the updated table columns, the index keys for the old values are generated during the deletion process and the index keys for the new values are generated during the insertion process. Subsequently, the old keys are deleted from the index while the new keys are inserted into the index.

If the updated columns are simple data types such as integer or character, then it is easy to detect if the column values in the index key did not change by comparing the old and new values in the table columns for the row being updated when the keys are generated. If the old and new values are the same, then the old index key does not need to be deleted from the index and the new index key does not need to be inserted into the index. Avoiding the updates to the index can be a beneficial performance saving.

For columns containing complex values such as XML documents, multiple index keys may be generated when the column is updated. Just comparing the old and new values in the table columns is not sufficient. For cases where only a small portion of the XML document is modified during the update and the majority of the document is left unchanged, old index keys to be deleted and new index keys to be inserted for the unmodified portions of the document may be identical. In these cases, many keys are deleted from the indexes only to be re-inserted later on. The net result is the same as if those deletes and inserts were never done at all. However, a big performance penalty is paid because of the cost to update the index for each of those keys. The index update is expensive due to the index tree traversal, I/O for the index pages, latching the index pages, binary searching and updating the pages, and logging the changes.

In the prior art, when an XML document is updated by full document replacement, the old document is traversed and all the nodes that match the specified index patterns are processed to build the corresponding index keys to delete. The delete keys are generated in a specific order (in order, post order, etc.) as the document is traversed. These keys to be deleted are then stored in a key buffer that can be either in memory or on disk. For large documents, the number of keys may exceed the size of an in-memory key buffer. In this case, a temporary file can be created on disk to store the keys that don't fit in the in-memory key buffer. When the new document is inserted on behalf of the update, the new document is parsed and all the nodes that match the specified index patterns are processed to build the corresponding index keys to insert. The insert keys are generated in the same order as the delete keys were generated as the document is traversed. These insert keys are then appended to the same key buffer that contains the delete keys.

After the entire XML document has been processed, the key buffer will contain all the keys to be deleted and inserted for all the indexes. At this point, each entry in the key buffer will be processed and depending on the mode, will either be deleted from the index or inserted into the index. For cases where only a small portion of the XML document is modified during the update and the majority of the document is left unchanged, the old index keys to be deleted and new index keys to be inserted for the unmodified portions of the document may be identical. In these cases, many keys are deleted from the indexes only to be re-inserted later on. The unnecessary index maintenance can be very costly.

### SUMMARY OF THE INVENTION

From the foregoing discussion, it should be apparent that a need exists for an apparatus, system, and method that reduce the overhead associated with index maintenance for update operations by only updating the indexes with the minimal delta changes needed. The invention can be used for indexes with an arbitrary number of key parts on a wide variety of indexable entities such as XML documents, HTML, tree structures, hierarchical data, and unstructured data. For some indexable entities, such as XML documents, multiple index keys may be generated when the indexable entity is processed during an update operation. Just comparing the old and new values for the indexable entity is not sufficient to determine if the index keys should be applied if the new indexable entity values are always different from the old indexable entity values. For cases where only a small portion of the indexable entity is modified during the update and the majority of the indexable entity is left unchanged, the old index keys to be deleted and the new index keys to be inserted for the unmodified portions of the indexable entity may be identical.

A tuple order for the index key parts may be defined to compare a set of index keys to be deleted against a set of index keys to be inserted and determine the delta key changes between them. Instead of deleting all of the index keys for an old indexable entity, only the old index keys which are not in the set of new index keys associated with a new indexable entity will be deleted. In addition, only the new index keys which are not in the set of old index keys will be inserted. Performance can be greatly improved by eliminating the deletions and insertions to the index for identical delete/insert index key pairs. For cases where only a small portion of an indexable entity is modified during an update and the majority of the indexable entity is left unchanged, this invention will result in both I/O and CPU savings.

The present invention has been developed in response to the present state of the art, and in particular, in response to the problems and needs in the art that have not yet been fully solved by currently available indexing systems. Accordingly, the present invention has been developed to provide an apparatus, system, and method for updating database indexes on complex data types that overcome many or all of the above-discussed shortcomings in the art.

The system to update database indexes is provided with a plurality of modules configured to functionally execute the necessary steps for improving update performance for indexes using delta key updates. These modules in the described embodiments include an index update module, a key generation module, and an index key comparison module.

In one embodiment, the system is configured to perform the operations of:

identifying at least one index comprised of index keys, the index keys defined by an index key definition and corresponding to nodes of an indexable entity; processing an old indexable entity in response to an update command; generating a set of delete index keys the delete index keys corresponding to nodes of the old indexable entity satisfying the index key definition of the index; processing a replacement indexable entity wherein the replacement indexable entity is intended to replace the old indexable entity in response to an update command; generating a set of insert index keys, the insert index keys corresponding to nodes of the replacement indexable entity satisfying the index key definition of the index; inserting into the index only the insert index keys that do not match one of the delete index keys; and deleting from the index only the delete index keys that do not match one of the at least one insert index keys.

In further embodiments, the system may be further configured to perform the operations of: storing the set of delete index keys in a buffer; storing each insert index key in the buffer in response to determining that the insert index key does not match one of the delete index keys; marking a delete index key with an identifier in response to determining that that delete index key matches one of the at least one insert index keys; and discarding each insert index key that does not match one of the delete index keys such that each matching insert index key is not stored in the buffer.

In one embodiment, deleting from the index only the delete index keys that do not match one of the at least one insert index keys is accomplished by deleting index keys from the index which correspond to delete index keys in the buffer not marked with the identifier. In a further embodiment, inserting into the index of an insert index key occurs in response to the insert index key remaining in the buffer after the replacement indexable entity has been completely processed. In yet a further embodiment, the old indexable entity is processed in the same order as the replacement indexable entity such that the set of delete index keys is generated in the same order as the set of insert index keys, and wherein the old indexable entity is processed only once to generate the set of delete index keys and the replacement indexable entity is processed only once to generate the set of insert index keys.

In one embodiment, the operations further comprise adding the set of delete index keys and the set of insert index keys into a list and sorting the delete index keys and insert index keys in the list to define index pairs and index singles based on one or more index key parts, an index pair comprising a delete index key and a matching insert index key, an index single comprising one of a single insert index key and a single delete index key. In an alternate embodiment, the set of delete index keys may be generated in a different order than the set of insert index keys.

In one embodiment, the indexable entity is an Extensible Markup Language (XML) document. In yet another embodiment, inserting insert index keys into and deleting delete index keys from the index may occur immediately in response to determining that a delete index key does not have a matching insert index key or that an insert index key does not have a matching delete index key such that the use of a buffer for storing the delete index keys and insert index keys may be avoided.

The apparatus is provided in various embodiments to perform the operations of: identifying at least one index comprised of index keys, the index keys defined by an index key definition and corresponding to nodes of an indexable entity in a database; processing an old indexable entity in response to an update command; generating a delete index key for each node of the old indexable entity that satisfies the index key definition, each delete index key corresponding to an index key stored in the at least one index; processing a replacement indexable entity, the replacement indexable entity configured to replace the old indexable entity in response to an update command; generating an insert index key for each node of the replacement indexable entity satisfying the index key definition; sorting the delete index keys and insert index keys in a list to define index pairs and index singles based on one or more index key parts, an index pair comprising a delete index key and a matching insert index key, an index single comprising one of a single insert index key and a single delete index key; deleting each index key from the index which corresponds to a single delete index key in the list; and inserting each single insert index key into the index.

The apparatus is further configured, in one embodiment, to store the delete index keys and insert index keys in a buffer prior to sorting. In a further embodiment, the apparatus may be configured to process the list and skip index pairs in the list such that index pairs are not applied to the index.

In various additional embodiments, the one or more index key parts may include a node identifier or a text value from the indexable entity. In at least one embodiment, at least one node of the old indexable entity is unchanged in a corresponding node of the replacement indexable entity.

A method of the present invention is also presented for updating database indexes on complex data types. The method in the disclosed embodiments substantially includes the steps necessary to carry out the functions presented above with respect to the operation of the described apparatus and system. In one embodiment, the method includes storing each insert index key in the buffer in response to determining that the insert index key does not match any of the delete index keys stored in the buffer; marking each delete index key that matches one of the insert index keys with an identifier; inserting into the index each insert index key stored in the buffer; deleting from the index only the index keys corresponding to delete index keys in the buffer that are not marked with the identifier; and inserting into the index each insert index key stored in the buffer.

The method also may include discarding each insert index key that matches one of the delete index keys in the buffer such that the matching insert index key is not stored in the buffer.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for updating database indexes on complex data types in accordance with the present invention;

FIG. 2 is a schematic block diagram illustrating one embodiment of an index manager in accordance with the present invention;

FIG. 3 is a schematic block diagram illustrating one embodiment of a indexable entity in document form and in tree structure form.

FIG. 4 is a schematic block diagram illustrating one embodiment of an old indexable entity (old document) to be deleted and a replacement indexable entity (new document) to be inserted; and

FIG. 5 is a schematic flow chart diagram illustrating one embodiment of a method for updating database indexes on complex data types in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a signal bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

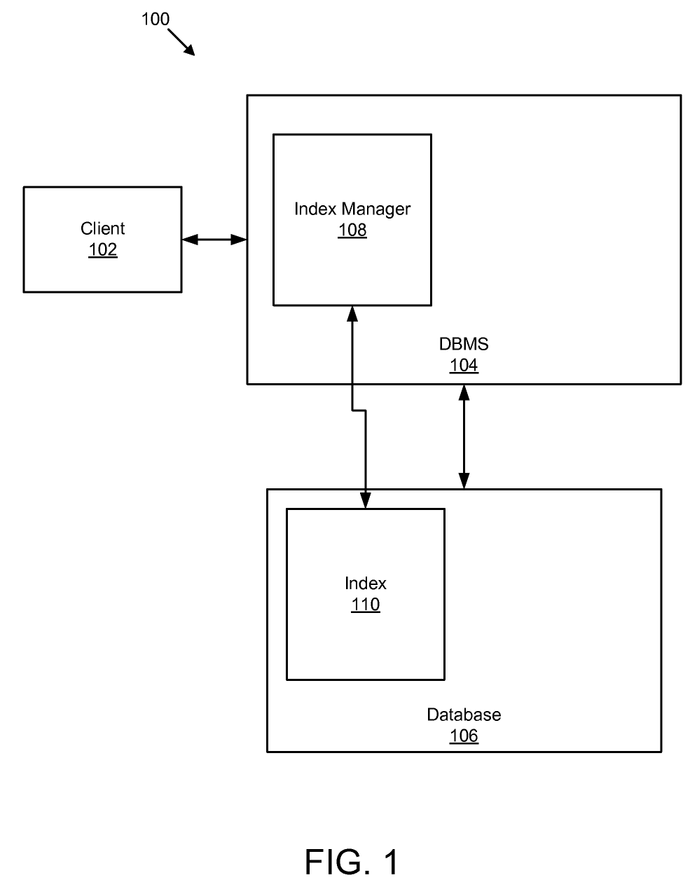

FIG. 1 depicts a schematic block diagram illustrating one embodiment of a system 100 for updating database indexes on complex data types in accordance with the present invention. The system 100 includes a client 102, a Database Management System (DBMS) 104, and a Database 106.

The client 102 is in electronic communication with the DBMS 104. Typically, a client 102 is a computer system that accesses a service on another computer by some kind of network. In one embodiment, as will be recognized by one of skill in the art, the client 102 may be a computer application, such as a web browser, that runs on a local computer or workstation and connects to the DBMS 104 as necessary. In one embodiment, the client 102 may be a DB2 client available from IBM of Armonk, N.Y. for use in conjunction with one of IBM's line of DB2 information management systems.

The DBMS 104 includes an index manager 108 and for managing an index 110. As will be recognized by one of skill in the art, a DBMS 104 is a computer or server that is running computer software designed for the purpose of managing databases. Typical examples of DBMSs include Oracle, DB2, Microsoft Access, Microsoft SQL Server, Postgre SQL, MySQL and FileMaker. The DBMS 104 is in electronic communication with the client 102 and the database 106. Preferably, the DBMS 104 is a DB2 DBMS from IBM's line of relational DBMSs.

The index manager 108 includes the logic necessary for updating and maintaining the database index 110. A database index 110 is typically a data structure that improves the speed of operations in a table. Indexes 110 can be created using one or more columns, providing the basis for both rapid random lookups and efficient ordering of access to records. The disk space required to store the index 110 is typically less than the storage of the table (since indexes usually contain only the key-fields according to which the table is to be arranged, and excludes all other details in the table. In a database 106 an index 110 is typically a copy of part of a table. In some embodiments, indexes 110 may be created on functions or expressions. For example, an index 110 could be created on upper(first_name), which would only store the uppercase versions of the first_name field in the index 110.

In one embodiment, the index 110 is a clustered index. Clustered indexes 110 are indexes that are built based on the same key order by which the data is ordered on the disk. In some DBMSs 104, a clustered index 110 corresponds to the actual data, not simply a pointer to data that resides elsewhere, as is the case with a non-clustered index 110.

The index manager 108 preferably includes the logic necessary to perform the operations necessary to update database indexes 110 on indexable entities. In various embodiments, the index manager 108 may be used on indexes 110 with an arbitrary number of key parts on a wide variety of indexable entities such as XML documents, HTML, tree structures, hierarchical data, unstructured data, and complex data structures generally.

Examples throughout this description demonstrate the invention as applied to data in Extensible Markup Language (XML) format. XML is a general-purpose markup language derived from the Standard Generalized markup Language (SGML). Its primary purpose is to facilitate the exchange of a wide variety of data across different systems especially systems connected via the Internet. XML provides a text-based way to describe and apply a tree-based structure to information. Markup tags such as element and attribute tags are a way to describe and separate the character data in order to store it in a hierarchical structure. An XML document can be stored in a database 106 as a tree structure with nodes to represent elements, attributes, text, etc with parent-child relationships between the nodes. Because XML data is stored in a hierarchical structure, a path of element tags is used to traverse the tree structure to access each node.

To improve performance during queries on XML data, indexes 110 can be created on specific paths and/or values in XML documents. In one embodiment, multiple indexes 110 can exist on the same XML document. A pattern may be used for an XML index 110 so that only the matching paths and/or values will be indexed. In various embodiments, the key parts for an XML index 110 may consist of one or more of a path ID, value, document ID, and a reference to the corresponding node. Additional key parts may be present for more efficient processing such as flags. Different types of XML indexes 110 may be created depending on which key parts are used and the order that the key parts are defined.

In one embodiment, a tuple order for the index key parts is defined to compare a set of index keys to be deleted against a set of index keys to be inserted as is discussed in detail below. Instead of deleting all of the index keys for an old indexable entity, only the old keys which are not in a set of replacement index keys will be deleted from the index 110. In addition, only the new or replacement index keys that are not already in the set of old index keys will be inserted in to the index 110. Performance may be greatly improved by eliminating the deletion and insertion operations for identical delete/insert index key pairs.

In one embodiment, the index manager 108 may be configured to manage load replace operations where the number of values being replaced is much smaller than the number of total existing values. In this embodiment, old values in a table can be deleted and new values may be inserted into the table which will cause index keys to be generated and applied. This can be faster than rebuilding the entire index 110 from scratch, particularly if the index 110 is large.

The database 106 includes an index 110 and can be a relational database for storing data that includes indexable entities. As will be recognized by one skilled in the art, a relational database 106 is a database that conforms to a relational model as applied to the format of the database's data and schema. In other words, a relational database 106 is a defined set of relations or tables which is used to organize data into rows and columns.

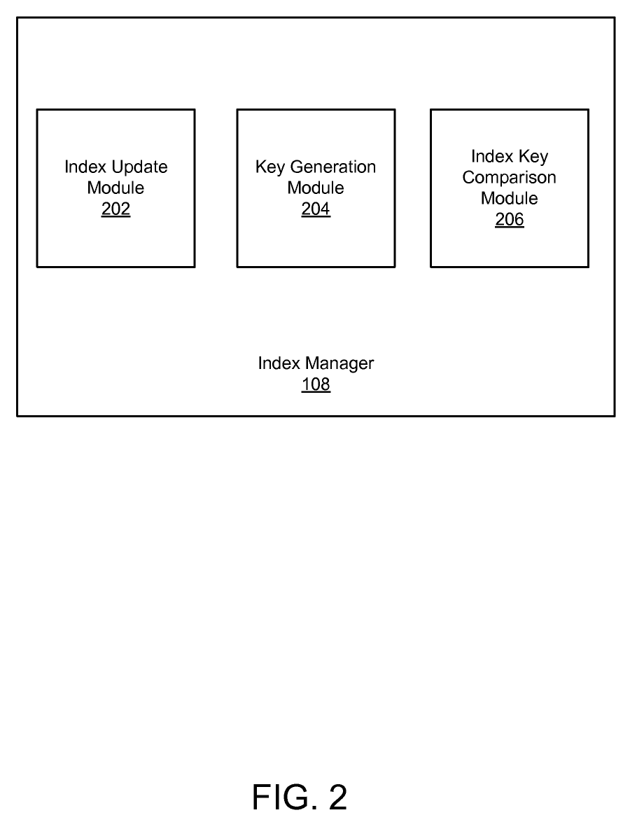

FIG. 2 is a schematic block diagram illustrating one embodiment of an index manager 108 in accordance with the present invention. In one embodiment, the index manager 108 includes an index update module 202, a key generation module 204, and an index key comparison module 206.

The index update module 202 may be configured to identify at least one index 110 comprised of index keys, the index keys defined by an index key definition and corresponding to an indexable entity in a database 106. In such an embodiment, the key generation module 204 may be configured to process an old indexable entity in response to an update command wherein the old indexable entity is to be updated with a new or replacement indexable entity. The key generation module 204 may generate a set of delete index keys for the old indexable entity that satisfies the key definition wherein each delete index key corresponds to an index key stored in the at least one index 110.

Similarly, with regard to a replacement indexable entity, the key generation module 204 may process the replacement indexable entity in response to an update command and may generate a set of insert index keys for the replacement indexable entity satisfying the index key definition.

In a further embodiment where the indexable entity is an XML document, processing the indexable entity includes the operation of traversing the XML document and finding the document nodes that match the index definition to generate the set of delete index keys and the set of insert index keys.

In one embodiment, the key generation module may generate a set of delete index keys in a different order from the set of insert index keys and put both sets of keys in a list.

In a further embodiment, the index key comparison module 206 may sort the delete index keys and insert index keys in the list to define index pairs and index singles based on one or more index key parts. An index pair is a delete index key and a matching insert index key, and an index single is one of a single insert index key and a single delete index key. The index update module 202 may then delete each index key from the index 110 which corresponds to a single delete index key in the list, and may insert each single insert index key into the index 110. In this manner, only the index keys that are changing in response to the update will be processed and changed in the index 110.

In an alternate embodiment, the key generation module may process the old indexable entity in the same order as the replacement indexable entity such that the set of delete index keys is generated in the same order as the set of insert index keys. The old indexable entity is only processed once to generate the set of delete keys and the replacement indexable entity is only processed once to generate the set of insert keys. Multiple passes through the indexable entity and a sort of the index keys are not required in this case.

In a further embodiment, the key generation module 204 may store each delete index key in a buffer, and the index key comparison module 206 may store each insert index key in the buffer in response to determining that the insert index key does not match any of the delete index keys stored in the buffer. The index update module 206 then may mark each delete index key in the buffer that matches one of the insert index keys with an identifier. Subsequently, the index update module 206 may delete from the index only the index keys corresponding to delete index keys in the buffer that are not marked with the identifier and may insert into the index 110 each insert index key that is stored in the buffer. In this manner, only those index keys in the index 110 that need updating due to the change from the old indexable entity to the new indexable entity will be changed in the index 110.

In a further embodiment, the index key comparison module 206 may be configured to perform an update delta check. The update delta check processes an index key according to a key mode, such as a delete mode or an insert mode, and handles matching and updating of match and write cursors. Delete index keys, or keys in the delete mode, are simply added to a buffer; and, insert index keys, or keys in the insert mode, are compared to the delete index keys in the buffer prior to insertion into the buffer.

During initialization, a write cursor may be set to the start of the empty buffer. The write cursor advances when a delete index key or insert index key is added to the buffer and always points to the last key in the buffer. In the beginning, all the delete index keys are added to the buffer. When the first new insert index key is processed, the index key module 206 begins the matching process. To begin, a match cursor is set to the first delete index key in the buffer. If the new insert index key matches the delete index key, then the delete index key is marked with an identifier, such as a ‘skip’ identifier. Then, the match cursor is advanced to the next delete index key, and the new insert index key is not inserted into the buffer. If the new insert index key does not match the delete index key, then either the match cursor is advanced or the new insert index key is inserted into the buffer depending on the result of the key comparison. In one embodiment, if the delete index key is greater than the insert index key, then the insert index key will be added to the buffer and a buffer entry count may be incremented. If the delete index key is less than the insert index key, then the match cursor is advanced.

Preferably, a loop will continue to advance the match cursor and compare the next delete index key to the next insert index key until either the insert index key is added to the buffer or a match is found, thereby indicating that the delete index key can be skipped and the insert index key can be discarded. A count of the number of skipped delete index keys and a count of the number of buffer entries may be used in one embodiment to break out of the loop.

After all the keys are processed, all the delete index keys that matched one of the insert index keys will have been marked with the ‘skip’ identifier, and only those insert index keys that need to be processed will have been inserted into the buffer. Thus, when the key buffer is processed any delete index keys that are marked as ‘skip’ need not be deleted from the index 110. Next, the delete index keys not marked as ‘skip’ and the insert index keys that were inserted into the buffer may be processed as deletions and insertions on the index 110.

In one embodiment, the index key definition may have the following key part order: path ID, text value, document ID, and node ID. By way of definition, a document ID is a unique number assigned to identify each indexable entity in the database 106; a node ID is a unique number assigned to identify and track each node of an indexable entity; a path ID is a unique number assigned to identify each unique path in the database 106; and an index ID is a unique number assigned to identify each index 110.

In one embodiment, a tuple order definition for the index key parts may be defined for comparing the delete index keys with the insert index keys. Various order types may include an index key definition order, a key generation order, and a comparison order. The index key definition order is the order of key parts defined during index creation; the key generation order is the order of key parts used when generating the index keys to add to the buffer; and the comparison order is an order of key parts used to compare the buffer entries. The buffer entries may contain more key parts than the index key definition in various embodiments (ie: may include an index ID).

In various embodiments, the comparison order needed to perform an update delta check operation may have the same order as the index key definition order or a different order to match the key generation order. Thus, the tuple order definition can be different to match the keys being generated in node ID order as the indexable entity is processed and the index pattern is matched. If the tuple order for the key comparison is the same as the key generation order, then a physical sort of the index keys may be avoided. The match cursor and write cursor may then be advanced based on the ordering of key parts for the buffer entries. If the ordering key parts of the buffer entries don't match, then the cursor with the lower value is advanced, and the match cursor is advanced to the next buffer entry. If the match cursor finishes processing all the delete index keys, the cursor may be set to null. For the write cursor, “advancing” means that the new insert index key may be added to the buffer.

In one embodiment, the node ID may be the ordering key part of the buffer entries for a logical sort and merge. If multiple indexes 110 exist, then an index ID may be added as an ordering key part after the node ID to distinguish between different indexes 110.

In a further embodiment, a data value of the index keys may be composed of the path ID and key value. When the index key comparison module 206 determines that the ordering key parts are all equal, it knows that the same node is being compared thereby indicating a match. In one embodiment, if the data values are identical for both the delete index key and new insert index key, then the delete index key is marked with a ‘skip’ identifier and a count of the number of skipped delete index keys may be incremented. Then the match cursor is advanced to the next delete index key, and the insert index key is not inserted into the buffer. If the data values are not the same, then the match cursor may be advanced (delete index key not marked as ‘skip’), and the new insert index key may be inserted into the buffer.

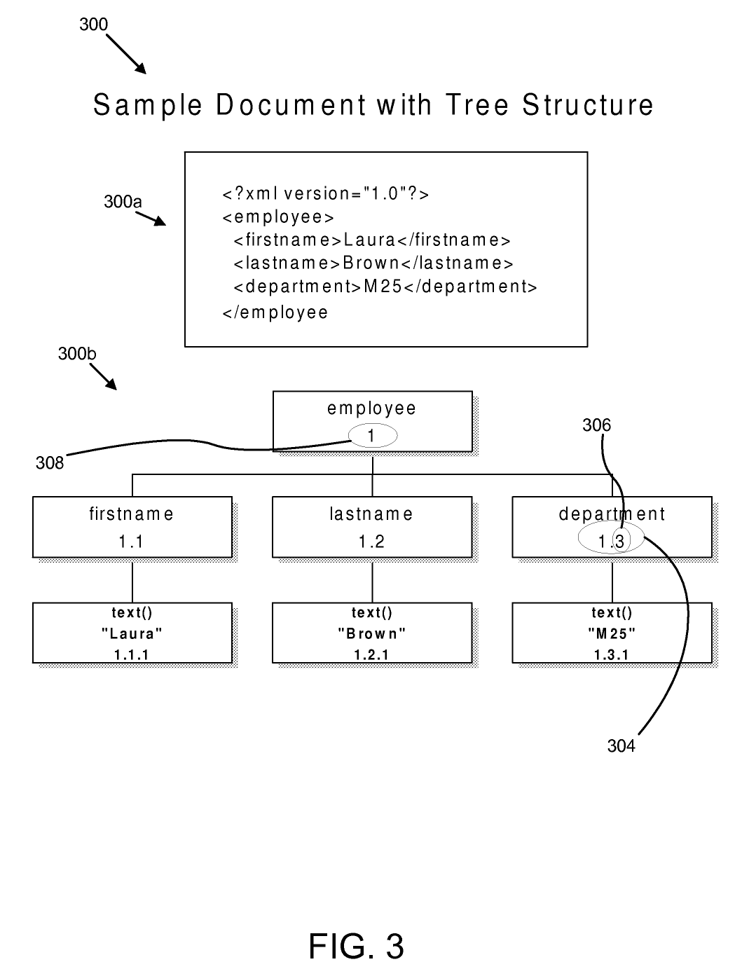

FIG. 3 is a schematic block diagram illustrating one embodiment of an indexable entity 300 (XML) in document form 300a and in tree structure form 300b. In one embodiment, the complete ID of each node in the indexable entity 300 is the node ID digit appended to the node ID of its parent node. For example, the ‘department’ node has the complete ID 304 of ‘1.3’. The ‘department’ node is the third child of the ‘employee’ node so it has the node ID digit 306=‘3’. Its parent node is ‘employee’ which has the node ID 308

As will be recognized by one skilled in the art, an index 110 can be created on specific paths and/or values in XML documents 300, and multiple indexes 110 can exist on the same XML document 300. A pattern may be used for an XML index 110 so that only the matching paths and/or values will be indexed. In various embodiments, the key parts for an index key may include a path ID, value, document ID, and a reference to the corresponding node. Additional key parts may be present for more efficient processing such as flags. Different types of XML indexes 110 can be created depending on which key parts are used and the order that the key parts are defined.

In one embodiment, a reference to a node of the indexable entity 300 is a way to access the node. It can be a direct pointer to the node such as a physical page number and slot number containing the offset into the page. It can also be a logical reference such as a node ID where the document can be traversed until the matching node ID is found. For this invention disclosure, assume that node IDs are being used as a logical reference to the nodes.

Thus, referencing FIG. 3, an XML index 110 maybe created on the value of the <firstname> element by choosing the pattern ‘/employee/firstname’ so that the value of “Laura” with node ID=1.1.1 is indexed in the index 110. For another example, suppose that an index 110 is defined in the index key definition for the pattern ‘//text( )’ to index all the ‘text’ nodes in the indexable entity 300. Suppose also that the index keys are comprised of a text value and node ID associated with each text node in the indexable entity 300. Then, an example of the index keys for the indexable entity 300 within the index 110 might look like this (in this example the index keys are ordered based on the text value):
Brown, 1.2.1
Laura, 1.1.1
M25, 1.3.1

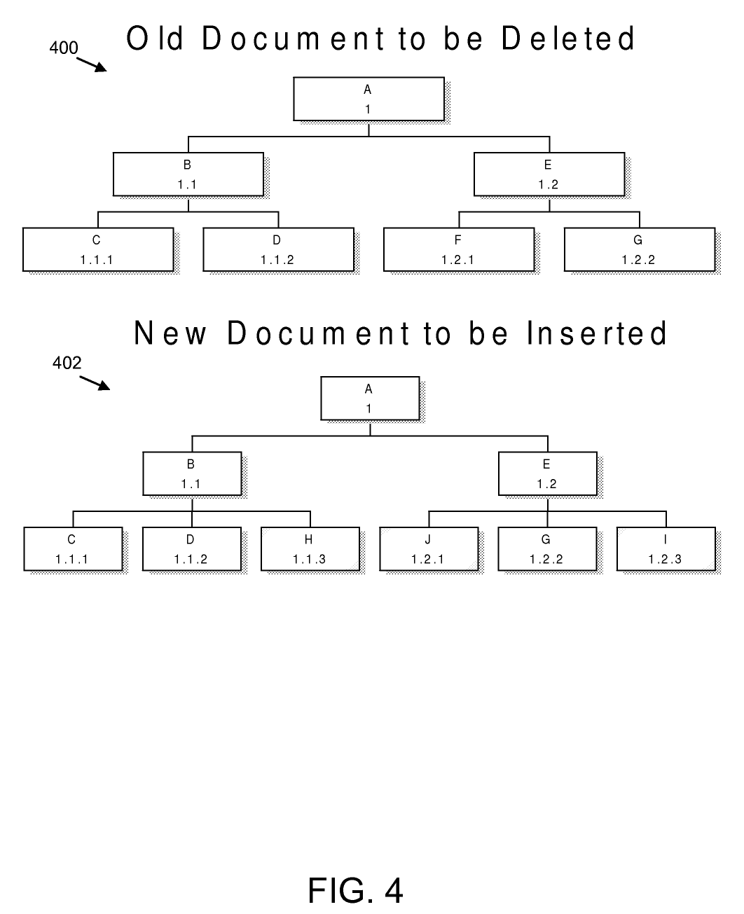

FIG. 4 is a schematic block diagram illustrating one embodiment of an old indexable entity (old document) 400 to be deleted and a replacement indexable entity (new document) 402 to be inserted in place of the old document 400. As depicted the old document 400 includes the nodes A, B, C, D, E, F, and G; and the new document 402 includes the nodes A, B, C, D, E, G, H, I, and J. Note that nodes F, H, I, and J are different between the old document 400 and the new document 402 and may require some updating of the index 110, whereas nodes A, B, C, D, E, and G will remain unchanged between the old document 400 and new document 402. Therefore, updates in the index 110 based on those nodes will not be required.

In one embodiment of the present invention, as applied to the old document 400 and new document 402, an index 110 comprised of index keys corresponding to nodes of the old document 400 is identified. For this example, assume that all of the leaf nodes in the documents 400 and 402 are indexed in the index 110. In this embodiment, the old document 400 is traversed and a delete index key for each indexed node of the old document 400 is generated (C, D, F, and G) and stored in a buffer. Next, the new document 402 is traversed and an insert index key is generated for each indexed node in the new document (C, D, H, J, G, and I) 402 and each insert index key is added to the buffer such that the buffer looks like this:

Index Key Buffer Prior to Sort

| Mode | Node ID | Data Values |
|---|---|---|
| Delete | 1.1.1 | C |
| Delete | 1.1.2 | D |
| Delete | 1.2.1 | F |
| Delete | 1.2.2 | G |
| Insert | 1.1.1 | C |
| Insert | 1.1.2 | D |
| Insert | 1.1.3 | H |
| Insert | 1.2.1 | J |
| Insert | 1.2.2 | G |
| Insert | 1.2.3 | I |

In one embodiment, a physical sort of the insert index keys and delete index keys stored in the buffer is performed to determine pairs of matching insert index keys and delete index keys. In this embodiment the delete and insert index key entries are physically sorted based on their key parts after they have been added to the buffer such that matches of identical delete index keys and insert index keys may be determined. In one embodiment, the delete and insert index keys may be checked to ensure that they have the same document ID prior to an update of the index 110. When updating the index 110 after a physical sort of the buffer, all of the identical insert/delete index key pairs are skipped during processing so that those key entries are not applied to the index 110, and all of the insert/delete index key singles in the buffer are processed as either a deletion or insertion into the index 110. In this manner, only those index keys in the index 110 that are affected by the update of the new document 402 will be processed. In the event that the number of index keys exceeds the size of the buffer, the delete and insert index keys may spill over to a temporary file. Here is one embodiment of the buffer after a physical sort is performed:

Key Buffer: After Physical Sort

| Mode | Skip | Node ID | Data Values |
|---|---|---|---|
| Delete | Yes | 1.1.1 | C |
| Insert | Yes | 1.1.1 | C |
| Delete | Yes | 1.1.2 | D |
| Insert | Yes | 1.1.2 | D |
| Insert | | 1.1.3 | H |
| Delete | | 1.2.1 | F |
| Insert | | 1.2.1 | J |
| Delete | Yes | 1.2.2 | G |
| Insert | Yes | 1.2.2 | G |
| Insert | | 1.2.3 | I |

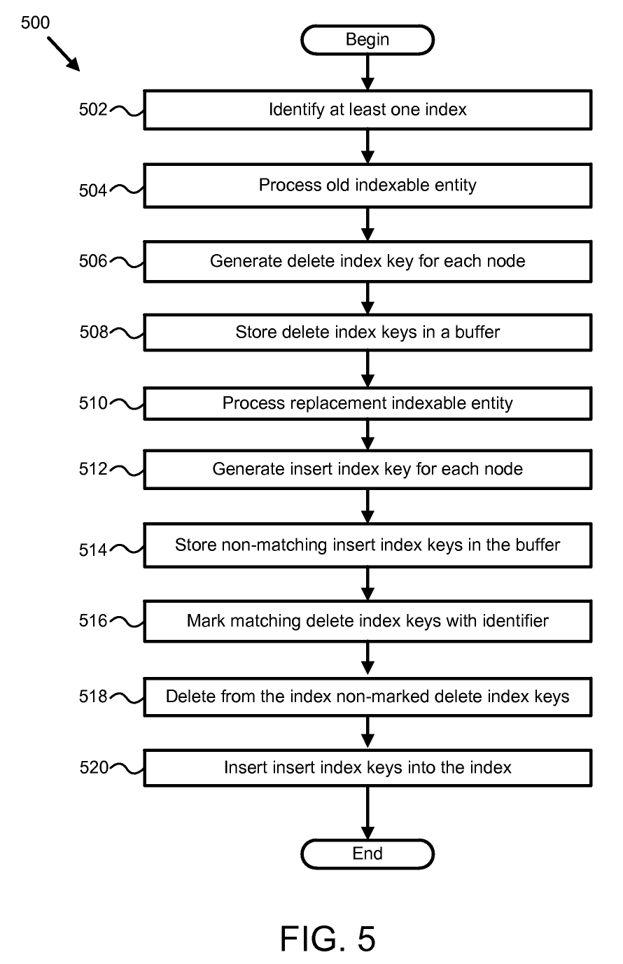

In a preferred embodiment, a logical sort merge of insert index keys with delete index keys is performed as depicted in FIG. 5 by the method 500. A logical sort merge may be performed in accordance with the present invention where the insert and delete index keys have the same document ID; the documents 400 and 402 are traversed in a specified order (ie: in order, post order, etc.) for both documents; and if there are multiple indexes 110 created on a column, then they are processed in a specified order that is the same for both the delete and insert paths.

The method 500 begins when the index update module 202 identifies 502 at least one index 110 comprised of index keys. The index keys are defined by an index key definition and correspond to nodes of a database column storing a indexable entity 400 in a database 106. In at least one embodiment, during initialization of the buffer, a write cursor may be set to the start of the empty buffer. The write cursor advances when a delete index key or insert index key is added to the buffer and always points to the last index key in the buffer. Next, the key generation module 204 processes 504 the old document 400 in response to an update command and generates 506 a delete index key for each node of the old document 400 that satisfies the index key definition of the index 110. In various embodiments, processing a document 400 or 402 may include traversing the document. In at least one embodiment, each delete index key corresponds to an existing index key stored in the at least one index 110. In one embodiment, each delete index key is stored in a buffer such that buffer looks like this:

Key Buffer: After Delete Keys Added

| Mode | Skip | Node ID | Data Values |
|---|---|---|---|
| Delete | | 1.1.1 | C |
| Delete | | 1.1.2 | D |
| Delete | | 1.2.1 | F |
| Delete | | 1.2.2 | G |

Next, the key generation module 204 processes 510 the new document 402 and generates 512 an insert index key for each node of the new document 402 that satisfies the index key definition of the index 110. As each insert index key is generated by the key generation module 204, a comparison is performed by the index key comparison module 206 to determine whether each of the at least one delete index keys stored in the buffer matches one of the at least one index index keys. In one embodiment, each generated insert index key that does not match any of the delete index keys stored in the buffer is subsequently stored 514 in the buffer as well, and each generated insert index key that does match one of the delete index keys stored in the buffer is discarded. The storage of the insert index key in the buffer indicates that the insert index key does not have a matching delete index key and therefore should be applied to the index 110 (as described below).

If the index key comparison module 206 determines that the generated insert index key matches a delete index key in the buffer then the delete index key is marked with an identifier such as a ‘skip’ identifier. The identifier indicates that a delete index key does have a matching insert index key, and therefore, an update to the index 110 for that delete index key may not be necessary. In one embodiment, a match cursor is set to the first delete index key in the buffer. If a newly generated insert index key matches the delete index key, then the delete index key is marked as “skip” so it will not be deleted from the index 110. Then, the match cursor is advanced to the next delete index key and the new insert index key is not inserted into the buffer. Conversely, if the new insert index key does not match the delete index key, then either the match cursor is advanced or the new key is inserted into the buffer depending on the result of a comparison of the key parts. Thus, in one embodiment, after the unmatched insert index keys are added, the buffer looks like this:

Key Buffer: After Insert Keys Added

| Mode | Skip | Node ID | Data Values |
|---|---|---|---|
| Delete | Yes | 1.1.1 | C |
| Delete | Yes | 1.1.2 | D |
| Delete | | 1.2.1 | F |
| Delete | Yes | 1.2.2 | G |
| Insert | | 1.1.3 | H |
| Insert | | 1.2.1 | J |
| Insert | | 1.2.3 | I |

The resulting buffer shows that three delete index keys can be skipped during an index 110 update and that their three matching insert index keys were not even added to the buffer. The processing steps, in one embodiment, may be defined as follows:
1. insert key has node ID(1.1.1) and data values(C)
   match cursor->node ID(1.1.1)=insert->node ID(1.1.1)
   match cursor->data values(C)=insert->data values(C)
   mark delete key as Skip=Yes and advance the match cursor
2. insert key has node ID(1.1.2) and data values(D)
   match cursor->node ID(1.1.2)=insert->node ID(1.1.2)
   match cursor->data values(D)=insert->data values(D)
   mark delete key as Skip=Yes and advance the match cursor
3. insert key has node ID(1.1.3) and data values(H)
   match cursor->node ID(1.2.1)>insert->node ID(1.1.3)
   insert key with node ID(1.1.3)
4. insert key has node ID(1.2.1) and data values(J)
   match cursor->node ID (1.2.1)=insert->node ID(1.2.1)
   match cursor->data values(F)!=insert->data values(J)
   insert key with node ID(1.2.1) data values (J) and advance match cursor
5. insert key has node ID(1.2.2) and data values(G)
   match cursor->node ID(1.2.2)=insert->node ID(1.2.2)
   match cursor->data values(G)=insert->data values(G)
   mark delete key as Skip=Yes and advance the match cursor (match cursor set to null since no more delete entries to match)
6. insert key has node ID(1.2.3) and data values(I)
   insert key with node ID(1.2.3) and data values(I) since match cursor is null

Next, the index update module 202, deletes 518 from the index 110 only the index key corresponding to delete index keys in the buffer that are not marked with the ‘skip’ identifier and inserts 520 into the index 110 each insert index key stored in the buffer. Thus, the index key ‘1.2.1, F’ is deleted from the index 110 and the index keys ‘1.1.3, H’, ‘1.2.1, J’, and ‘1.2.3, I’ are inserted into the index 110. In this manner, the index 110 is updated such that only those index keys that are affected by the update to the new document 402 will be processed. The method 300 ends.

In further embodiments, multiple indexes 110 may exist. In such a situation, an index ID may be added as a key part to distinguish between the different indexes. For example, suppose another index 110 was added to the previous example such that an index with index ID=1 matched all the leaf nodes of the documents 400 and 402 (ie: C, D, F, G, H, I, J) and an index 110 with index ID=2 only matched the leaf nodes in the second subtree of the documents 400 and 402 (ie: F, G, J, I). A processing order may be maintained so that the index with ID=1 is always processed first and the index with ID=2 is always processed second. Now that a node can match multiple indexes 110, the buffer prior to a physical sort of the associated delete and insert index keys might look like this:

Key Buffer With Two Indexes Prior to Sort

| Mode | Node ID | Index ID | Data Values |
|---|---|---|---|
| Delete | 1.1.1 | 1 | C |
| Delete | 1.1.2 | 1 | D |
| Delete | 1.2.1 | 1 | F |
| Delete | 1.2.1 | 2 | F |
| Delete | 1.2.2 | 1 | G |
| Delete | 1.2.2 | 2 | G |
| Insert | 1.1.1 | 1 | C |
| Insert | 1.1.2 | 1 | D |
| Insert | 1.1.3 | 1 | H |
| Insert | 1.2.1 | 1 | J |
| Insert | 1.2.1 | 2 | J |
| Insert | 1.2.2 | 1 | G |
| Insert | 1.2.2 | 2 | G |
| Insert | 1.2.3 | 1 | I |
| Insert | 1.2.3 | 2 | I |

In a logical sort merge embodiment, the buffer may look like this prior to the processing of any insert index keys:

Key Buffer: After Delete Keys Added for Two Indexes

| Mode | Skip | Node ID | Index ID | Data Values |
|---|---|---|---|---|
| Delete | | 1.1.1 | 1 | C |
| Delete | | 1.1.2 | 1 | D |
| Delete | | 1.2.1 | 1 | F |
| Delete | | 1.2.1 | 2 | F |
| Delete | | 1.2.2 | 1 | G |
| Delete | | 1.2.2 | 2 | G |

After a logical sort merge as described above, the delete index keys with a matching insert index key (including index ID) will be marked with a ‘skip’ identifier; the insert index keys with a matching delete index key will not be added to the buffer, and the insert index keys without a matching delete index key will be added to the buffer. The resulting buffer shows that four delete index keys can be skipped and their four matching insert keys were not even added to the key buffer. Thus, a total of seven index key entries will be applied to the index 110 as opposed to a total of fifteen index key entries that would be applied using conventional indexes without the invention. Here is the buffer after the insertion of insert index keys:

Key Buffer: After Insert Keys Added for Two Indexes

| Mode | Skip | Node ID | Index ID | Data Values |
|---|---|---|---|---|
| Delete | Yes | 1.1.1 | 1 | C |
| Delete | Yes | 1.1.2 | 1 | D |
| Delete | | 1.2.1 | 1 | F |
| Delete | | 1.2.1 | 2 | F |
| Delete | Yes | 1.2.2 | 1 | G |
| Delete | Yes | 1.2.2 | 2 | G |
| Insert | | 1.1.3 | 1 | H |
| Insert | | 1.2.1 | 1 | J |
| Insert | | 1.2.1 | 2 | J |
| Insert | | 1.2.3 | 1 | I |
| Insert | | 1.2.3 | 2 | I |

The processing steps for a multiple index logical sort merge, in one embodiment, may be defined as follows:
1. insert key has node ID(1.1.1), index ID(1), and data values(C)
   match cursor->node ID(1.1.1)=insert->node ID(1.1.1)
   match cursor->index ID(1)=insert->indexID(1)
   match cursor->data values(C)=insert->data values(C)
   mark delete key as Skip=Yes and advance the match cursor
2. insert key has node ID(1.1.2), index ID(1), and data values(D)
   match cursor->node ID(1.1.2)=insert->node ID(1.1.2)
   match cursor->index ID(1)=insert->indexID(1)
   match cursor->data values(D)=insert->data values(D)
   mark delete key as Skip=Yes and advance the match cursor
3. insert key has node ID(1.1.3), index ID(1), and data values(H)
   match cursor->node ID(1.2.1)>insert->node ID(1.1.3)
   insert key with node ID(1.1.3), index ID(1), and data values(H)
4. insert key has node ID(1.2.1), index ID(1), data values(J)
   match cursor->node ID (1.2.1)=insert->node ID(1.2.1)
   match cursor->index ID(1)=insert->indexID(1)
   match cursor->data values(F)!=insert->data values(J)
   insert key with node ID=1.2.1, index ID(1), data values (J) and advance match cursor
5. insert key has node ID(1.2.1), index ID(2), data values(J)
   match cursor->node ID (1.2.1)=insert->node ID(1.2.1)
   match cursor->index ID(2)=insert->indexID(2)
match cursor->data values(F)!=insert->data values(J)
   insert key with node ID(1.2.1), index ID(2), data values(J) and advance match cursor
6. insert key has node ID(1.2.2), index ID(1), data values(G)
   match cursor->node ID(1.2.2)=insert->node ID(1.2.2)
   match cursor->index ID(1)=insert->indexID(1)
   match cursor->data values(G)=insert->data values(G)
   mark delete key as Skip=Yes and advance the match cursor
7. insert key has node ID(1.2.2), index ID(2), data values(G)
   match cursor->node ID(1.2.2)=insert->node ID(1.2.2)
   match cursor->index ID(2)=insert->indexID(2)
   match cursor->data values(G)=insert->data values(G)
   mark delete key as Skip=Yes and advance the match cursor (match cursor set to null since no more delete entries to match)
8. insert key has node ID(1.2.3), index ID(1), data values(I)
   insert key with node ID(1.2.3), index ID(1), data values(I) since match cursor is null
9. insert key has node ID(1.2.3), index ID(2), data values(I)
   insert key with node ID(1.2.3), index ID(2), data values(I) since match cursor is null

In an alternate embodiment, the key generation module processes the old indexable entity in the same order as the replacement indexable entity and maintains one cursor on the old indexable entity and another cursor on the replacement indexable entity. Because the set of delete index keys is generated in the same order as the set of insert index keys, the cursors can be used to maintain position as the old indexable entity and the replacement indexable entity are processed. The index update delta check can be used but instead of using a buffer to hold the set of delete index keys and the set of insert index keys and updating the index later on with keys stored in the buffer, the operations to the index can be applied immediately as the delete index keys and insert index keys are generated and compared.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system for updating database indexes, the system comprising:
a database;
a database management system (DBMS) for managing the database, the DBMS comprising an index manager configured to perform operations comprising:
identifying at least one index comprised of index keys, the index keys defined by an index key definition and corresponding to nodes of an indexable entity;
processing an old indexable entity in response to an update command;
generating a set of delete index keys, the delete index keys corresponding to nodes of the old indexable entity satisfying the index key definition of the index;
processing a replacement indexable entity wherein the replacement indexable entity is intended to replace the old indexable entity in response to an update command;
generating a set of insert index keys, the insert index keys corresponding to nodes of the replacement indexable entity satisfying the index key definition of the index;
inserting into the index only the insert index keys that do not match one of the delete index keys; and
deleting from the index only the delete index keys that do not match one of the insert index keys.

2. The system of claim 1, wherein the operations further comprise storing the set of delete index keys in a buffer.

3. The system of claim 2, wherein the operations further comprise storing each insert index key in the buffer in response to determining that the insert index key does not match one of the delete index keys.

4. The system of claim 3, wherein the operations further comprise marking a delete index key with an identifier in response to determining that that delete index key matches one of the insert index keys.

5. The system of claim 4, wherein deleting from the index only the delete index keys that do not match one of the insert index keys is accomplished by deleting index keys from the index which correspond to delete index keys in the buffer not marked with the identifier.

6. The system of claim 5, wherein the operations further comprise discarding each insert index key that does not match one of the delete index keys such that each matching insert index key is not stored in the buffer.

7. The system of claim 6, wherein the inserting into the index of an insert index key occurs in response to the insert index key remaining in the buffer after the replacement indexable entity has been completely processed.

8. The system of claim 7, wherein the old indexable entity is processed in the same order as the replacement indexable entity such that the set of delete index keys is generated in the same order as the set of insert index keys, and wherein the old indexable entity is processed only once to generate the set of delete index keys and the replacement indexable entity is processed only once to generate the set of insert index keys.

9. The system of claim 1, wherein the operations further comprise adding the set of delete index keys and the set of insert index keys into a list and sorting the delete index keys and insert index keys in the list to define index pairs and index singles based on one or more index key parts, an index pair comprising a delete index key and a matching insert index key, an index single comprising one of a single insert index key and a single delete index key.

10. The system of claim 1, wherein the set of delete index keys is generated in a different order than the set of insert index keys.

11. The system of claim 1, wherein the indexable entity is an Extensible Markup Language (XML) document.

12. The system of claim 1, wherein inserting insert index keys into and deleting delete index keys from the index occurs immediately in response to determining that a delete index key does not have a matching insert index key or that an insert index key does not have a matching delete index key such that the use of a buffer for storing the delete index keys and insert index keys may be avoided.

13. A computer program product comprising a computer readable medium having computer usable program code stored on a tangible medium and executable on a processor to perform operations for updating database indexes, the operations of the computer program product comprising:
identifying at least one index comprised of index keys, the index keys defined by an index key definition and corresponding to nodes of an indexable entity in a database;
processing an old indexable entity in response to an update command;
generating a delete index key for each node of the old indexable entity that satisfies the index key definition, each delete index key corresponding to an index key stored in the at least one index;
processing a replacement indexable entity, the replacement indexable entity configured to replace the old indexable entity in response to an update command;
generating an insert index key for each node of the replacement indexable entity satisfying the index key definition;
sorting the delete index keys and insert index keys in a list to define index pairs and index singles based on one or more index key parts, an index pair comprising a delete index key and a matching insert index key, an index single comprising one of a single insert index key and a single delete index key;
deleting each index key from the index which corresponds to a single delete index key in the list; and
inserting each single insert index key into the index.

14. The computer program product of claim 13, further comprising storing the delete index keys and insert index keys in a buffer prior to sorting.

15. The computer program product of claim 13, further comprising processing the list and skipping index pairs in the list such that index pairs are not applied to the index.

16. The computer program product of claim 13, wherein the one or more index key parts comprises a node identifier.

17. The computer program product of claim 13, wherein the one or more index key parts comprises a text value from an indexable entity.

18. The computer program product of claim 13, wherein at least one node of the old indexable entity is unchanged in a corresponding node of the replacement indexable entity.

19. A computer program product comprising a computer readable medium having computer usable program code stored on a tangible medium and executable on a processor to perform operations for updating database indexes, the operations of the computer program product comprising:
identifying at least one index comprised of index keys, the index keys defined by an index key definition and corresponding to nodes of an indexable entity in a database;
processing an old indexable entity in response to an update command;
generating a delete index key for each node of the old indexable entity that satisfies the index key definition of the index, each delete index key corresponding to an existing index key stored in the at least one index;
storing the generated delete index keys in a buffer;
processing a replacement indexable entity wherein the replacement indexable entity is intended to replace the old indexable entity in response to an update command;
generating an insert index key for each node of the replacement indexable entity satisfying the index key definition of the index;
storing each insert index key in the buffer in response to determining that the insert index key does not match any of the delete index keys stored in the buffer;
marking each delete index key that matches one of the insert index keys with an identifier;
deleting from the index only the index keys corresponding to delete index keys in the buffer that are not marked with the identifier; and
inserting into the index each insert index key stored in the buffer.

20. The computer program product of claim 16, further comprising discarding each insert index key that matches one of the delete index keys in the buffer such that the matching insert index key is not stored in the buffer.
